(19) United States
(12) Patent Application Publication
(10) Pub. No.: US 2008/0061683 A1
(43) Pub. Date: Mar. 13, 2008

(54) Illumination System

(75) Inventor: Dietrich Bertram, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,577

(22) PCT Filed: Sep. 19, 2005
(86) PCT No.: PCT/IB05/53059

§ 371 Date: Mar. 20, 2007

(30) Foreign Application Priority Data
Sep. 27, 2004 (EP) 04104691.3

(51) Int. Cl. H01J 1/62

(52) U.S. Cl. 313/504

(57) ABSTRACT

An illumination system has at least one organic light-emitting diode (1) deposited on a rigid and translucent substrate (11). The organic light-emitting diode includes first (3) and second (4) electrodes for providing electrical power to the organic light-emitting diode. The substrate at a side facing away from the organic light-emitting diode is arranged on a translucent waveguide (15). The waveguide at a side facing away from the organic light-emitting diode is provided with means (25) for coupling out light emitted by the organic light-emitting diode. In operation, light generated by the organic light-emitting diode travels through the substrate and the waveguide and is emitted by the illumination system in a direction substantially normal to the waveguide. Preferably, the illumination system comprises a plurality of organic light-emitting diodes arranged on the translucent waveguide. According to the invention, light emission by the illumination system is improved.

The invention relates to an illumination system comprising at least one organic light-emitting diode (OLED).

Such illumination systems are known per se. They are used, inter alia, as backlighting of (image) display devices, for example for television receivers and monitors. Such illumination systems can particularly suitably be used as a backlight for non-emissive displays, such as liquid crystal display devices, also referred to as LCD panels, which are used in (portable) computers or (cordless) telephones. Another application area of the illumination system according to the invention is the use in display devices taking over the function of paper are often referred to as “electronic paper” or “paper white” applications (electronic newspapers, electronic diaries). The illumination systems according to the invention are further used for general lighting purposes and for large-area direct-view light emitting panels such as applied, for instance, in signage, contour lighting, and billboards. In addition, such illumination systems are employed in electrographic print engines.

An organic light-emitting diode (OLED) normally is disposed between two electrodes, e.g. a cathode and an anode. Upon applying a voltage from a power source across electrodes, the OLED provides a continuous light-emitting area.

The German Utility Model DE-U 202 07 799 describes an illumination system for use as an indicator lamp in vehicles. The known illumination system comprises a rigid, non-transparent substrate provided with a foil comprising an organic light-emitting diode (OLED). In an embodiment of the known illumination system, a number of OLED foils are combined on a flexible support. A drawback of the known illumination system is that the organic light-emitting diodes are not bright enough to provide sufficient light in the desired application.

The invention has for its object to eliminate the above disadvantage wholly or partly. According to the invention, this object is achieved by an illumination system comprising:
at least one organic light-emitting diode deposited on a rigid and translucent substrate, the organic light-emitting diode including first and second electrodes for providing electrical power to the organic light-emitting diode,
the substrate at a side facing away from the organic light-emitting diode being arranged on a translucent waveguide,
the waveguide at a side facing away from the organic light-emitting diode being provided with means for coupling out light emitted by the organic light-emitting diode,
in operation, light generated by the organic light-emitting diode traveling through the substrate and the waveguide, and being emitted by the illumination system in a direction substantially normal to the waveguide.

By disposing the organic light-emitting diode (OLED) on a translucent substrate, light generated by the OLED easily propagates through the substrate. In addition, by arranging that the substrate at a side facing away from the organic light-emitting diode is in optical contact with the translucent waveguide, light propagation in the waveguide is stimulated. By providing the waveguide at a side facing away from the organic light-emitting diode with means for coupling out light emitted by the organic light-emitting diode, the illumination system, in operation, emits light in a direction substantially normal to the waveguide. The light emitted by the illumination system according to the invention is in principle isotropic. According to the invention, an illumination system comprising an OLED is provided with an improved brightness, i.e. the light per unit area from the light source is increased. By arranging the substrate with the OLED on a waveguide in this manner, the light normally trapped in the substrate is coupled out of the substrate without or with minimum light losses.

Preferably, the rigid and translucent substrate is made of glass. Glass is optically transparent with a refractive index of approximately 1.45. Glass sheets can be made with relatively high flatness facilitating the deposit of relatively large areas of organic light-emitting diodes without defects.

There is a tendency to increase the effective viewing area of display devices. Such applications require a light source with a relatively large illumination area emitting light in a homogeneous and uniform manner. From a manufacturing point of view, the provision of a single, large-area OLED without defects becomes less feasible. To this end a preferred embodiment of the illumination system according to the invention is characterized in that the illumination system comprises a plurality of organic light-emitting diodes arranged on the translucent waveguide. Such an arrangement with a multiplicity of OLEDs arranged on the translucent waveguide has several advantages. By arranging a plurality of OLEDs an illumination system with a relatively large illumination area can be realized. In such an illumination system, the OLEDs are provided, preferably, adjacent to each other. An additional advantage of this preferred embodiment of the illumination system is that OLEDs of different colors can be employed, for instance a mix of red, blue and green OLEDs or a mix of red, amber blue and green OLEDs. Preferably, the light emitted by the plurality of differently colored OLEDs is mixed in the waveguide in such a manner that, for instance, white light of a pre-determined color temperature is emitted by the illumination system. Employing a plurality of OLEDs facilitates the exchange of an individual, malfunctioning OLED. In the event of an exchange, the OLED including its substrate is easily removed from the waveguide and another OLED provided on a substrate is arranged at the same location on or in the waveguide. Another advantage of this preferred embodiment of the illumination system is that the OLEDs can either be powered parallel or that (groups of) OLEDs are powered separately. This allows the realization of a multiplicity of lighting modes by the illumination system. By switching on and off certain OLEDs and or by regulating the current over the OLED, the color emitted by the illumination system can be influenced and/or the color temperature can be adapted. By controlling the luminous fluxes of individual or groups of OLEDs in response to the conditions of the images to be displayed on a display device, the contrast of the image to be displayed can be enhanced. If, by way of example, the illumination level of an image to be displayed by the display device is comparatively low, for example in the case of a scene in nocturnal conditions in a video film, a corresponding reduction of the light output of the OLEDs can be realized. In that case, the illumination system couples out a comparatively small amount of light for illuminating the display device. The pixels of the display device do not have to be pinched to reduce the light emitted by the illumination system. In this manner, the transmission of the pixels of the display device can be optimally used to display a high-contrast image. In this manner high-contrast images can be obtained, in spite of a comparatively low illumination level of the image to be displayed by the display device.

Preferably, the luminous fluxes of the (groups of) OLEDs are controlled by a control circuit. It is particularly suitable if such a control circuit can be influenced by the user of the assembly, through a sensor which, for example, measures the color temperature of the ambient light, through a video card of, for example, a (personal) computer and/or through drive software of a computer program. The amount of light emitted by the OLEDs is adjusted by varying the luminous fluxes of the relevant organic light-emitting diodes. This luminous flux control operation generally takes place in a very energy-efficient manner. For example, OLEDs can be dimmed without an appreciable loss of light output.

Preferably, side faces of the substrate are reflective or are provided with a specular reflecting layer. This reduces the losses in the illumination system.

In a preferred embodiment of the illumination system according to the invention is characterized in that the side faces of the substrate are tapered, the substrate broadening in the direction of the light emission. In this manner a wedge-shaped substrate is obtained. Light traveling through the substrate and hitting the tapered side faces is reflected toward the side of the substrate facing away from the OLED.

An alternative, preferred embodiment of the illumination system according to the invention is characterized in that at least part of the substrate is embedded in the waveguide. By providing the waveguide with indented portions, the insertion of the OLED is facilitated. In addition, light emitted from side edges is captured by the waveguide.

Preferably, side faces of the waveguide are reflective or are provided with a specular reflecting layer. This reduces the losses in the illumination system.

Preferably, the refractive indices of the substrate and the waveguide are substantially the same. In a favorable embodiment of the illumination system, the substrate and the waveguide are made from the same rigid material, for example glass. If there is a mismatch between the refractive index of the substrate and the waveguide, this mismatch is preferably relatively small. To this end a preferred embodiment of the illumination system according to the invention is characterized in that a refractive index step between a refractive index of the substrate and a refractive index of the waveguide is less than or equal to 0.5. The refractive index of the waveguide is preferably higher than that of the substrate to stimulate outcoupling of the light from the substrate into the waveguide. In this manner, the waveguide functions as an antireflective layer on the substrate. Preferably, optical contact between the substrate and the waveguide is promoted by an index-matching fluid.

The brightness of the illumination system can be further improved by blocking and/or reflecting the light emitted by the OLED in a direction facing away from the substrate. To this end a preferred embodiment of the illumination system according to the invention is characterized in that the electrode facing away from the substrate is made reflective for reflecting the light emitted by the organic light-emitting diode towards the substrate.

A preferred embodiment of the illumination system according to the invention is characterized in that the waveguide is covered with a luminescent material for converting part of the light emitted by the organic light-emitting diode to a different color. For instance blue OLEDs are employed to pump a yellow phosphor for creating white light, or green OLEDs are employed to pump a yellow phosphor for creating yellow light. An advantage of using a luminescent material is that light outcoupling from the waveguide is stimulated.

These and other aspects of the invention are apparent from and will be elucidated with reference to the embodiments and drawings described hereinafter:

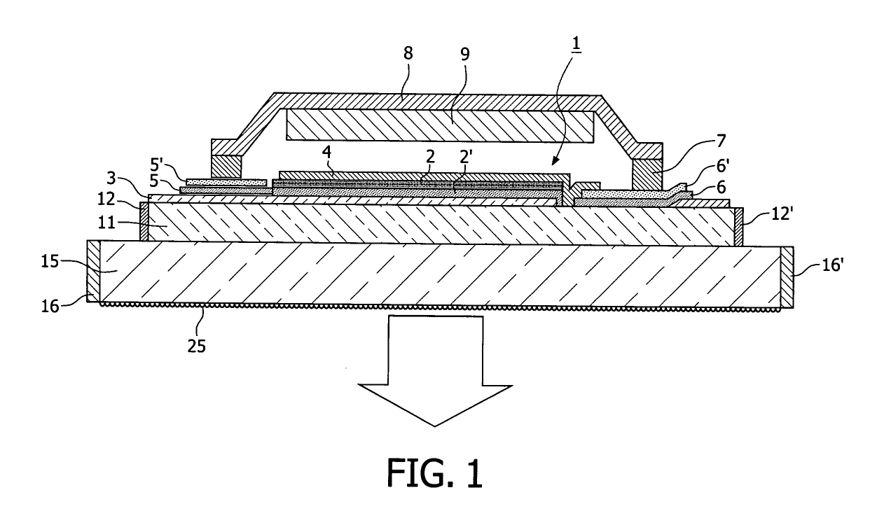

FIG. 1: is a cross-sectional view of an embodiment of the illumination system according to the invention;

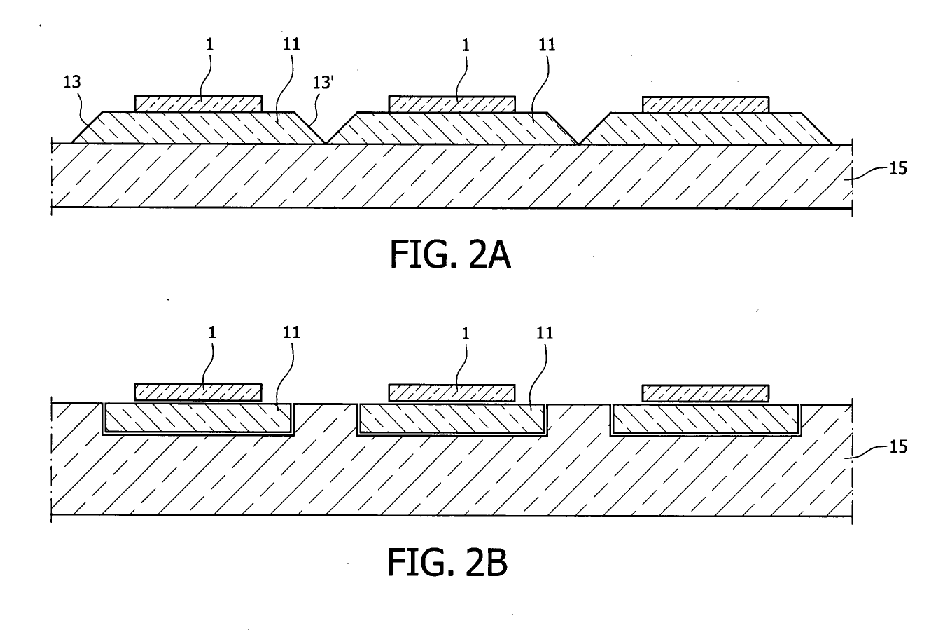

FIG. 2A: is a cross-sectional side view of a first embodiment of the illumination system comprising a plurality of organic light-emitting diodes arranged on the translucent waveguide, and

FIG. 2B: is a side view of a second embodiment of the illumination system comprising a plurality of organic light-emitting diodes arranged on the translucent waveguide.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1 very schematically shows a cross-sectional view of a cross-sectional view of an embodiment of the illumination system according to the invention. The illumination system comprises at least one organic light-emitting diode (OLED) 1 deposited on a rigid and translucent substrate 11. The translucent substrate is, preferably, made of glass. The thickness of the substrate is typically 0.7 mm. In the example of FIG. 1, side faces of the substrate 11 have been provided with a specular reflecting layer 12, 12′. In yet another embodiment, side faces of the substrate are tapered (see FIG. 2A), the substrate broadening in the direction of the light emission.

The OLED 1 comprises at least one organic layer 2, 2′ (in the example of FIG. 1 two organic layers are shown) disposed between a first electrode 3 and a second electrode 4 for providing electrical power to the organic light-emitting diode 1. One of these electrodes referenced 3, acts as anode and is made of an optical translucent electrode and is, preferably made of indium tin oxide. The other electrode referenced 4, acts as cathode and is, preferably made of a metal layer, for instance of barium/aluminum, magnesium/aluminum, lithium fluoride/aluminum, cesium/aluminum, magnesium/silver. The relative locations of the anode and the cathode may be reversed with respect to the substrate 11. The electrode 3 in between the organic layer 2, 2′ and the substrate is made of a translucent of transparent material in order to allow passage of light emitted by the organic layer 2, 2′ into the substrate 11. The organic light-emitting diode emits light upon application of a voltage from a power source (not shown in FIG. 1) across the electrodes 3, 4. The OLED 1 refers to the combination of the organic layer 2, 2′ and the electrodes 3, 4. A typical thickness of the OLED 1 is 200 nm. In FIG. 1, the layers referenced 5 and 6 are contact metal layers. A number of auxiliary metallization layers 5′ and 6′ is included for providing contact to the OLED from outside the package.

At a side facing away from the substrate, the OLED 1 is covered by a cover lid 8. The space between the OLED 1 and the cover lid is provided with a getter 9. The cover lid 8 is mounted on the electrodes via a seal 7. The getter 9 provides the desired atmosphere for the OLED 1, in particular, absorbs any water and oxygen in the vicinity of the OLED 1.

At a side facing away from the organic light-emitting diode 1, the substrate 11 is arranged on a translucent waveguide 15. The waveguide is preferably made of a rigid and translucent material, preferably glass or polymethyl methacrylate (pmma), polycarbonate or polyethylene terephthalate (PET). Preferably, side faces of the waveguide 15 are made reflective or are provided with a specular reflecting layer 16, 16′.

At a side of the waveguide 15 facing away from the organic light-emitting diode 1, the waveguide is provided with means 25 for coupling out light emitted by the organic light-emitting diode 1. Such means 25 are known per se and comprise, for example, a foil or a coating provided on the waveguide 15 or comprise grooves embedded in the waveguide 15. In operation, light generated by the organic light-emitting diode 1 travels through the substrate 11 and the waveguide 15, and is emitted by the illumination system in a direction substantially normal to the waveguide 15 (see the broad arrow in FIG. 1). The light emitted by the illumination system according to the invention is isotropic.

By arranging the substrate 11 with the OLED 1 on a waveguide 15 in the above-described manner, light normally trapped in the substrate 11 is coupled out of the substrate 11 without or with minimum light losses. An advantage of the illumination system according to the invention is that light outcoupling from light emitted by the organic light-emitting diodes is largely improved. In the known illumination system the coupling between the OLED and the waveguide is relatively inefficient; approximately 50% of the light emitted by the OLED does not enter the waveguide. In addition, only approximately 50% of the light in the waveguide is emitted by the waveguide. This results in a light outcoupling of light emitted by the OLED of approximately only 25%. The arrangement of the OLED 1, substrate 11 and waveguide 15 according to the invention results in a substantially higher amount of light coupled out from the illumination system.

Preferably, the refractive indices of the substrate 11 and the waveguide 15 are practically the same. Preferably, the substrate 11 and the waveguide 15 are both made from the same rigid material, preferably, glass. If there is a mismatch between the refractive index of the substrate 11 and the waveguide 15, for example if the substrate 11 is made of glass (refractive index n=1.45) and the waveguide 15 is made of pmma (refractive index n=1.49), this mismatch is preferably relatively small. In this case the refractive index step between the refractive index of the substrate 11 and the refractive index of the waveguide 15 is smaller than 0.5. If there is a difference between the refractive index of the waveguide 15 and that of the substrate 11, the refractive index of the waveguide 15 is preferably higher than that of the substrate. Such a difference stimulates the outcoupling of light from the substrate 11 into the waveguide 15. In this manner, the waveguide 15 functions as an antireflective layer on the substrate. An index-matching liquid (not shown in FIG. 1) may be provided between the substrate 11 and the waveguide 15 for promoting the light coupling between the substrate 11 and the waveguide 15. The refractive index of the index-matching liquid is, preferably, between the refractive index of the substrate 11 and the waveguide 15.

Additionally, the waveguide can be covered with a luminescent material for converting part of the light emitted by the organic light-emitting diode to a different color. For instance blue OLEDs are employed to pump a yellow phosphor for creating white light. In another example, green OLEDs are employed to pump a yellow phosphor for creating yellow light. In yet another example, UV-A emitting OLEDs are employed to pump a blue phosphor for creating white light. Semiconductor nanoparticles can be employed as luminescent material. Such materials comprise particles with a characteristic dimension between 1 and 10 nm and are, preferably, made of I-V, II-V or group IV materials.

FIG. 2A very schematically shows a cross-sectional side view of a first embodiment of the illumination system comprising a plurality of organic light-emitting diodes arranged on the translucent waveguide. For clarity reasons each of the plurality of organic light-emitting diodes is referenced 1. Each of the OLEDs 1 is disposed on a substrate 11. A plurality of OLEDs I disposed on substrates 11 are arranged on the translucent waveguide 15. In FIG. 2A an arrangement of OLEDs 1 is shown in one dimension. Preferably, the arrangement of the OLEDs 1 on the waveguide is a two-dimensional arrangement, OLEDS 1 extending in two mutually orthogonal directions.

By arranging a plurality of OLEDs 1 as exemplified in FIG. 2A, an illumination system with a relatively large illumination area is realized. In such an illumination system OLEDs of different colors are, preferably, employed, for instance a mix of red, blue and green OLEDs or a mix of red, amber blue and green OLEDs, or any other suitable mix of colors. As a result light of a pre-determined color is emitted by the illumination system. Employing a plurality of OLEDs facilitates the exchange of an individual, malfunctioning OLED. In the event of an exchange, the OLED including its substrate is easily removed from the waveguide and another OLED provided on a substrate is arranged at the same location on or in the waveguide. By switching on and off certain OLEDs and or by regulating the voltage over the OLED, the color emitted by the illumination system can be influenced and/or the color temperature can be adapted. In addition, by controlling the luminous fluxes of individual or groups of OLEDs in response to the conditions of the images to be displayed on a display device, the contrast of the image to be displayed can be enhanced. The luminous fluxes of the (groups of) OLEDs are, preferably, controlled by a control circuit.

In the example as shown in FIG. 2A, the side faces 13, 13′ of the substrate are tapered, the substrate 11 broadening in the direction of the light emission. In this manner a wedge-shaped substrate 11 is obtained. Light traveling through the substrate 11 and hitting the tapered side faces 13, 13′ is reflected toward the side of the substrate 11 facing away from the OLED 1.

FIG. 2B very schematically shows a side view of a second embodiment of the illumination system comprising a plurality of organic light-emitting diodes arranged on the translucent waveguide. For clarity reasons each of the plurality of organic light-emitting diodes is referenced 1. Each of the OLEDs 1 is disposed on a substrate 11. A plurality of OLEDs 1 disposed on substrates 11 are arranged on the translucent waveguide 15. In FIG. 2B an arrangement of OLEDs 1 is shown in one dimension. Preferably, the arrangement of the OLEDs 1 on the waveguide is a two-dimensional arrangement, OLEDS 1 extending in two mutually orthogonal directions.

In the example as shown in FIG. 2B, at least part of the substrate 11 is embedded in the waveguide 15. To this end, the waveguide 15 has been provided with indented portions, facilitation the insertion of the substrate 11 with the OLED 1 in the waveguide 15. In the example of FIG. 2B, the indented portions in the waveguide are made such that the entire substrate 11 can embedded in the waveguide 15. Mounting the substrate 11 in this manner further reduces light losses in the illumination system as light emitted from side edges of the substrate 11 is captured by the waveguide 15.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising:
at least one organic light-emitting diode (1) deposited on a rigid and translucent substrate (11), the organic light-emitting diode (1) including first (3) and second (4) electrodes for providing electrical power to the organic light-emitting diode (1),
the substrate (11) at a side facing away from the organic light-emitting diode (1) being arranged on a translucent waveguide (15),
the waveguide (15) at a side facing away from the organic light-emitting diode (1) being provided with means (25) for coupling out light emitted by the organic light-emitting diode (1),
in operation, light generated by the organic light-emitting diode (1) traveling through the substrate (11) and the waveguide (15), and being emitted by the illumination system in a direction substantially normal to the waveguide (15).

2. An illumination system as claimed in claim 1, wherein the illumination system comprises a plurality of organic light-emitting diodes (1) arranged on the translucent waveguide (15).

3. An illumination system as claimed in claim 1 wherein side faces of the substrate (11) are reflective or are provided with a specular reflecting layer (12, 12′).

4. An illumination system as claimed in claim 1, wherein side faces (13, 13′) of the substrate (11) are tapered, the substrate (11) broadening in the direction of the light emission.

5. An illumination system as claimed in claim 1, wherein at least part of the substrate (11) is embedded in the waveguide (15).

6. An illumination system as claimed in claim 1, wherein side faces of the waveguide (15) are reflective or are provided with a specular reflecting layer (16, 16′).

7. An illumination system as claimed in claim 1, wherein a refractive index step between a refractive index of the substrate (11) and a refractive index of the waveguide (15) is less than or equal to 0.5.

8. An illumination system as claimed in claim 1, wherein the rigid and translucent substrate (11) is made of glass.

9. An illumination system as claimed in claim 1, wherein the electrode (4) facing away from the substrate (11) is reflective for reflecting the light emitted by the organic light-emitting diode towards the substrate (11).

10. An illumination system as claimed in claim 1, wherein optical contact between the substrate (11) and the waveguide (15) is promoted by an index-matching fluid.

11. An illumination system as claimed in claim 1, wherein the waveguide (15) is covered with a luminescent material for converting part of the light emitted by the organic light-emitting diode (1) to a different color.
